(19) United States
(12) Patent Application Publication
(10) Pub. No.: US 2011/0184700 A1
(43) Pub. Date: Jul. 28, 2011

(54) METHOD AND DEVICE FOR THE DYNAMIC MONITORING OF A BROADBAND LAMBDA PROBE

(76) Inventors: Andreas Michalske, Kornwestheim (DE); Sascha-Juan Moran Auth, Esslingen (DE)

(21) Appl. No.: 13/055,791

(22) PCT Filed: Jul. 3, 2009
(86) PCT No.: PCT/EP09/58383

§ 371 Date: Apr. 6, 2011

(30) Foreign Application Priority Data
Jul. 25, 2008 (DE) 10-2008-040 737.2

(51) Int. Cl. G06F 15/00

(52) U.S. Cl. 702/182

(57) ABSTRACT

The invention relates to a method for monitoring dynamic characteristics of a broadband lambda probe (25), wherein a measured lambda signal corresponding to an oxygen concentration in the exhaust gas of an internal combustion engine (1) is determined using a broadband lambda probe (25), wherein an observer producing a modeled lambda signal from input variables is associated with the internal combustion engine (1), and wherein an estimation error signal is formed from the difference of the modeled lambda signal and the measured lambda signal or from the difference of signals derived therefrom as an input variable of a controller (14) connected upstream of a model (15) in the observer (10). The problem of the invention is solved by a measure being determined for the dynamic characteristics of the broadband lambda probe (25) from an evaluation of the estimation error signal or of a variable derived therefrom, and by this measure being compared to predefined limits in order to evaluate the dynamic characteristics of the broadband lambda probe (25).

### TECHNICAL FIELD

The invention relates to a method for monitoring dynamic characteristics of a broadband lambda probe, wherein a measured lambda signal corresponding to an oxygen concentration in the exhaust gas of an internal combustion engine is determined using a broadband lambda probe, wherein an observer producing a modeled lambda signal from input variables is associated with the internal combustion engine, and wherein an estimation error signal is formed from the difference of the modeled lambda signal and the measured lambda signal or from the difference of a signal derived from said modeled lambda signal and a signal derived from said measured lambda signal as an input variable of a controller connected upstream of a model in the observer.

The invention further relates to a device for monitoring dynamic characteristics of a broadband lambda probe, wherein an oxygen concentration in the exhaust gas of an internal combustion engine can be determined using the broadband lambda probe, wherein an engine control unit is associated with the internal combustion engine, wherein electrical circuitry or a program sequence is provided, which includes an observer producing a modeled lambda signal from input variables, and wherein an estimation error signal is formed from the difference of the modeled lambda signal and a lambda signal measured using said broadband lambda probe or from the difference of a signal derived from said modeled lambda signal and a signal derived from the measured lambda signal as an input variable of a controller connected upstream of a model in the observer.

In internal combustion engines operated with diesel fuel and having a lambda based control, the oxygen content of the exhaust gas can be measured using a broadband lambda probe and the exhaust gas quality can be optimized via an exhaust gas recirculation, the charging pressure and the initiation of injection. This control can further be used for optimizing the fuel consumption of the internal combustion engine. Due to the effects of ageing, the dynamic characteristics of the broadband lambda sensor can, however, change to such an extent that the response time and dead time thereof are no longer adequate for a sufficiently quick determination of the exhaust gas composition. As a result, the discharge of toxic emissions can increase.

In order to monitor the dynamic characteristics of broadband lambda sensors, the increase or decrease in the lambda probe signal is evaluated during certain changes in the engine operating state. In so doing, one of the following variables is typically used as a measure for the dynamic characteristics: delay time of a step response when a step change in the oxygen content of the exhaust gas occurs, gradient of the lambda probe signal or the ratio of the slopes of a measured to a calculated change in the oxygen content of the exhaust gas. The delay time of the step response is thereby designated as a time constant or t63 time. By way of example, these characteristic values are increased when the probe protection tube becomes fouled by soot or when a glazing of the diffusion barrier occurs.

According to prior art, an increase in the time until a first response of the broadband lambda probe to a step change in the mixture composition occurs, the so-called dead time, is not evaluated. Dead times result from transport processes as is exemplified by the runtimes of the exhaust gas from the exhaust valve of the internal combustion engine up to the broadband lambda probe. It can be expected that dead times of the broadband lambda probe, which are too large, will have to be detected in order to comply with future regulations for on-board diagnostics. It may be sufficient not to determine the dead time as such but only to compare a measure for the dead time with predefined limits.

It is therefore the aim of the invention to provide a method which allows for a reliable comparison of a step response of a broadband lambda probe with predefined limits when a step change in the oxygen content of the exhaust gas occurs and thus for a diagnosis of the dynamic characteristics of the broadband lambda probe. The method is preferably to be implemented without interventions into the air or injection systems. It is furthermore the aim of the invention to provide a device for carrying out the method according to the invention.

### SUMMARY

The problem of the invention relating to the method is thereby solved by a measure being determined for the dynamic characteristics of the broadband lambda probe, which are characterized by a dead time and a response time, from an evaluation of the estimation error signal or of a variable derived therefrom and by this measure for the dynamic characteristics being compared to predefined limits in order to evaluate to what extent the dynamic characteristics of the broadband lambda probe are sufficient for an intended operation of the internal combustion engine. The dynamic characteristics of the broadband lambda probe in the exhaust gas duct of an internal combustion engine operated with diesel fuel can be characterized by a response of the oxygen signal of said probe when a step change in the oxygen concentration in the exhaust gas occurs. This variable is designated as the oxygen step response. The oxygen step response can thereby be characterized by a response time or t63 time, which is the time from a first response of the signal up until 63% of the final value has been achieved, and by a dead time. A displacement of the signal to greater time values while the signal form remains the same is thereby designated as dead time. The method can be implemented as software in a control unit of the engine management system, wherein the control unit contains an electronic memory and the program code of the software is stored in a machine-readable memory.

The estimation error signal determined from the difference between a modeled lambda signal and a measured lambda signal becomes larger with increasing dead time. This is the case because the phase delay leads to an increase in the difference. It is an advantage of the method according to the invention that it can be configured as a passive method and step changes in the lambda of the exhaust gas do not have to be specifically provided in order to carry out said method. The modeling of the lambda signal can take place in a so-called “fuel mass observer” (FMO), which represents a model of the system to be controlled in a closed and/or open loop. In so doing, the model includes among other things a dead-time element and a first-order time-delay element in order to describe the behavior of the exhaust gas duct of the internal combustion engine and that of the broadband lambda probe. The FMO is an observer from the perspective of closed-loop control technology, which can be used for disturbance feedforward. The estimation error signal is supplied to this observer as an input signal via a controller. If the behavior of the real system changes as a result of errors or modification to the design of the internal combustion engine and the exhaust gas duct, this leads to estimation errors and correcting variable deflections of the observer FMO. Said method can be adequately carried out by implementing only parts of the FMO in an engine management system as a program sequence or electrical circuitry.

A dead time of the broadband lambda probe leads to a temporal displacement between the modeled lambda signal and the measured lambda signal. The area between the signal curves increases with increasing dead time and with an increasing time constant so that the dynamic characteristics of the broadband lambda probe can be determined from an integral of the absolute value or the square of the estimation error signal which is formed over a predefined length of time. The absolute value or the square of the estimation error signal is used so that areas below positive and negative curve sections can not compensate for each other. The transgression of a dead time of the broadband lambda probe considered to be critical can be linked to a value of the integral, which can be used as a first limit.

In one embodiment of the method according to the invention, conclusions can be drawn with regard to insufficient dynamics of the broadband lambda probe and an error message response and/or a compensatory response are only initiated if it is determined in a plurality of cases that the integral has exceeded a predefined first limit. Provision can be made for the error message response and or the compensatory response to only be initiated if it is determined in a plurality of cases that the predefined limit has been exceeded more often than not being met.

A further embodiment of the method provides a counter and makes provision for the counter to be incremented if the integral exceeds the predefined first limit, for said counter to be decremented or set to the counter reading zero if the integral does not meet a second predefined limit and for an error message response and/or compensatory response to be initiated if said counter reaches a predefined counter reading. By taking small values of the integral into account, a “cure” for the behavior of the broadband lambda probe can thus be taken into account so that a repeated on/off switching of a signal lamp (malfunction indicator lamp), which indicates a malfunction is present in the system, can be avoided. Provision can be made for the first and second limit to be the same; thus enabling said counter to be incremented if the limit is exceeded and to be decremented if the limit is not met.

In one configuration of the method, integrals of the estimation error signal are formed in a sliding manner by the integration taking place over a predefined length of time and by the initiation of the integration being displaced along a time axis. The starting time of an integration step can lie within the integration period of the preceding step so that the time periods of consecutive integrations overlap. According to methods of prior art, the values of the estimation error signal can for this reason be provided to a shift register or to a ring memory in the control unit and be processed in a suitable fashion. As previously described, the integrals formed in this way are compared to predefined limits.

Provision can be made for the inverted measured lambda signal or an oxygen signal to be used as the signal derived from the measured lambda signal and for the inverted modeled lambda signal or a modeled oxygen signal to be used as the signal derived from the modeled lambda signal.

Besides a dead time, an increased response time of the broadband lambda probe also increases the integral of the estimation error signal used for the evaluation. A modification to the inventive method therefore provides that a response time of the measured lambda signal of the broadband lambda probe is determined according to prior art and that an input of an extended response time to the integral, which has been formed, is taken into account when evaluating the dead time or a measure for said dead time. In this way, the two components rise time and dead time can be separated from each other and be separately evaluated when considering the dynamics of the broadband lambda probe.

After a diagnosis of an inadmissibly increased dead time and/or response time has taken place, provision can be made for a defective broadband lambda probe to be indicated to the operator of the internal combustion engine and/or to be recorded in an error memory. The indication can thereby by way of example take place by means of a “malfunction indicator lamp” MIL.

The control unit preferably contains at least one electrical memory, in which the procedural steps are deposited as the control unit program.

The control unit program according to the invention provides that all steps of the inventive method are executed if it is run in a control unit.

The control unit program product according to the invention having a program code stored on a machine-readable carrier executes the inventive method if the program is run in a control unit.

The problem of the invention relating to the device is solved by an electrical circuitry or a program sequence being provided for determining a measure for the dynamic characteristics of the broadband lambda probe from an evaluation of the estimation error signal or a variable derived therefrom and by a comparison of the measure for said dynamic characteristics of the broadband lambda probe with predefined limits being provided for determining to what extent said dynamic characteristics of the broadband lambda probe are sufficient for an intended operation of the internal combustion engine.

In total, the following is achieved by means of the inventive method and device. Besides being able to evaluate the response time of the broadband lambda probe, which can be determined according to prior art, the dead time of said probe can also be evaluated. In so doing, a message can then be indicated to the driver when predefinable limits have been exceeded.

### BRIEF DESCRIPTION OF THE DRAWINGS

The invention is explained below in detail using an exemplary embodiment depicted in the figures. The following are shown:

FIG. 1 a schematic depiction of the technical environment, in which the method is used and

FIG. 2 a diagram with the temporal course of a modeled and a measured lambda value.

### DETAILED DESCRIPTION

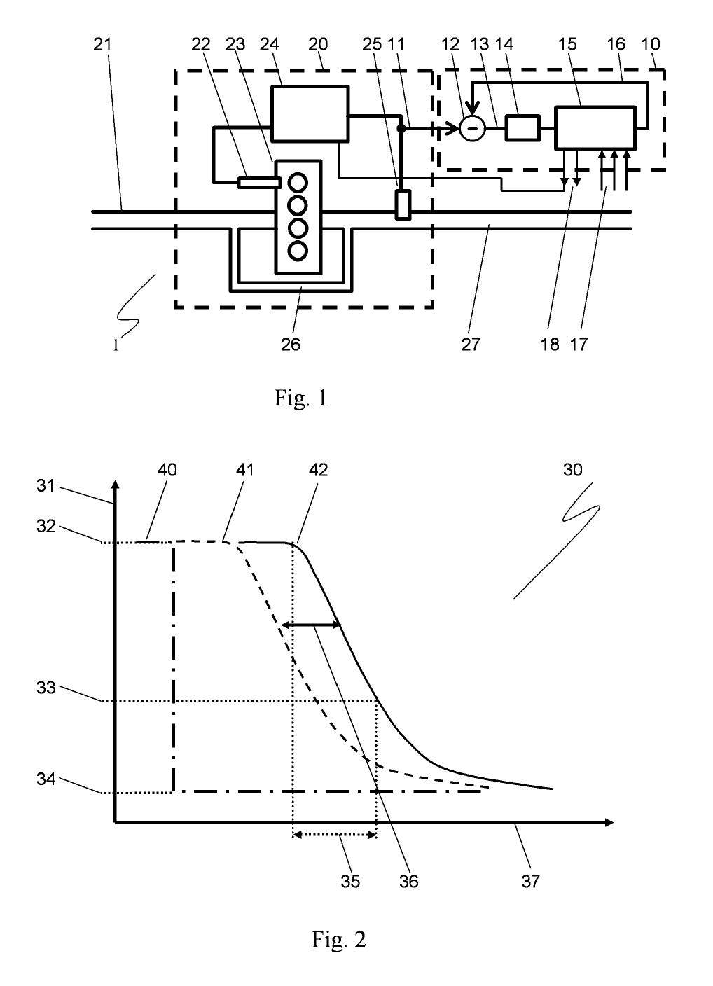

Using a possible embodiment, FIG. 1 shows a schematic depiction of the technical environment, in which the method according to the invention can be used. In so doing, the depiction confines itself to components which are necessary for the explanation of the invention. An internal combustion engine 1 having an exhaust gas probe in the form of a broadband lambda probe 25 is depicted. The internal combustion engine 1 consists of an engine block 23 having four cylinders. Fresh air is supplied to the engine block 23 via an intake air duct 21 and fuel, as by way of example diesel fuel, is supplied via a fuel metering device 22. An exhaust gas duct 27, wherein the broadband lambda probe 25 is disposed, is located downstream of said engine block 23. Said broadband lambda probe 25 emits a measured lambda signal 11. Via an exhaust gas recirculation 26, a predefinable proportion of exhaust gas can be mixed into the intake air in the intake air duct 21. An exhaust gas turbocharger for increasing the charging pressure of the intake air can also be provided. The fuel metering device 22 and said broadband lambda probe 25 are connected to an engine control unit 24. They form together with said engine block 23 and said exhaust gas duct 27 a controlled system 20. In an alternative embodiment, which is not depicted here, the lambda value can be set via the air path. Besides said fuel metering device 22, a valve in the exhaust gas recirculation 26 and/or a throttle valve in the air intake duct 21 can be used as an actuating element for setting the lambda value.

An observer 10, which consists of a controller 14 and a model 15, is associated with the internal combustion engine 1. Input variables 17, such as a driver command and measured variables from said internal combustion engine 1, are supplied to the model 15. A modeled lambda signal 16 is determined from said input variables 17 in said model 15. Said model emits output variables 18, a portion of which is supplied to the engine control unit 24. The modeled lambda signal 16 is subtracted from the measured lambda signal 11 in a subtraction stage 12, and an estimation error signal is thus formed which is supplied to the controller 14. The observer 10 is a model of the controlled system 20. In the present invention, a measure for the dynamic behavior of the broadband lambda probe 25 is determined from the estimation error signal 13.

FIG. 2 shows a diagram 30 in which a temporal course of an oxygen content 40 in the exhaust gas of the internal combustion engine 1 is plotted on a lambda axis 31 along a time axis 37. Furthermore, a modeled lambda value 41 and a measured lambda value 42 are plotted. The values fall starting from an initial value 32 to a final value 34. A response time 35 is depicted in the example of the measured lambda value 42, which is the time period between a first response of the measured lambda value 42 and the point in time, whereat 63% of the final value is achieved. This time period is also designated as t63 or the time constant. The 63% value 33 is plotted on the signal axis 31 based on the initial value 32 with respect to the final value 34. In addition, a dead time 36 is indicated in the diagram 30. Said dead time 36 is a displacement along the time axis 37 between the modeled lambda value 41 and the measured lambda value 42, said modeled lambda value 41 and said measured lambda value having in this case the same response time 35.

In the case of the depicted step change in the oxygen content 40, the course of the modeled lambda value 41, which is temporally delayed with respect to the oxygen content 40 and increases in response time 35, results from the parameters present in the observer 10. This temporal course corresponds to the course when an intact broadband lambda probe 25 is present. In the present inventive method, the integral of the absolute value of the difference between the measured lambda value 42 and the modeled lambda value 41 is formed over a predefined time period and is used in determining a measure for the dynamic characteristics of the broadband .lambda probe 25. This measure can be compared to predefined limits in order to evaluate to what extent the dynamic characteristics of said broadband lambda probe, as, for example, the dead time, meet the requirements. The method is also applicable if changes in the load, for example by means of driver input, lead to a change in the oxygen content in the exhaust gas.

If the dead time 36 of the broadband lambda probe 25 now increases, the measured lambda value 42 thereof is thus temporally displaced with respect to the modeled lambda value along the time axis 35 toward larger times and the integral formed therefrom increases. Likewise an increase in the response time 35 of the measured lambda value 42 leads to an increase in the integral used for evaluating the dynamics of the broadband lambda probe 25. The monitoring according to the invention can be realized by means of comparison to predefinable limits.

The method shown by way of example for the diesel engine is also possible with other forms of an internal combustion engine, as, for example, with an Otto engine, mixed forms between Otto and diesel engines, a combination of different drives (so-called “hybrids” or gas engines).

1. Method for monitoring dynamic characteristics of a broadband lambda probe, wherein a measured lambda signal corresponding to an oxygen concentration in the exhaust gas of an internal combustion engine is determined using a broadband lambda probe, wherein an observer producing a modeled lambda signal from input variables is associated with the internal combustion engine and wherein an estimation error signal is formed from the difference of the modeled lambda signal and the measured lambda signal or from the difference of a signal derived from the modeled lambda signal and a signal derived from the measured lambda signal as an input variable of a controller connected upstream of a model in the observer wherein a measure is determined for the dynamic characteristics of the broadband lambda probe wherein a dead time and a response time from an evaluation of the estimation error signal or a variable derived therefrom and in that the measure for the dynamic characteristics is compared to predefined limits in order to evaluate to what extent the dynamic characteristics of said broadband lambda probe are sufficient for an intended operation of said internal combustion engine.

2. Method according to claim 1, wherein the measure for the dynamic characteristics of the broadband lambda probe is determined from an integral of the absolute value or the square of the estimation error signal.

3. Method according to claim 1, wherein an error message response and/or a compensatory response is initiated if the integral exceeds a predefined first limit in a plurality of determinations.

4. Method according to claim 1, wherein a counter is incremented if the integral exceeds the predefined first limit, in that the counter is decremented or set to the counter reading zero if the integral does not meet a second predefined limit and in that an error message response and/or compensatory response is initiated if the counter reaches a predefined counter reading.

5. Method according to claim 1, wherein the integration takes place over the predefined time period and in that the initiation of the integration is displaced along a time axis.

6. Method according to claim 1, wherein the inverted measured lambda signal or an oxygen signal is used as the signal derived from the measured lambda signal and in that the inverted modeled lambda signal or a modeled oxygen signal as the signal derived from the modeled lambda signal.

7. Method according to claim 1, wherein a response time of the measured lambda signal of the broadband lambda probe is determined and in that an input of an extended response time to the integral, which has been formed, is taken into account when determining the dead time or a measure thereof.

8. Method according to claim 1, wherein a defective broadband lambda probe is indicated to the operator of the internal combustion engine and/or recorded in an error memory.

9. Computer program, which executes all steps of a method according to claim 1 if it is run on a computer.

10. Computer program product with program code, which is stored on a machine-readable carrier, for carrying out the method according to claim 1 if the program is executed on a computer or in a control unit.

11. Device for monitoring dynamic characteristics of a broadband lambda probe, wherein a measured lambda signal, which corresponds to an oxygen concentration in the exhaust gas of an internal combustion engine, can be determined using the broadband lambda probe, wherein an engine control unit is associated with the internal combustion engine, wherein an electrical circuitry or a program sequence is provided, which contains an observer that produces a modeled lambda signal from input variables, and wherein an estimation error signal is formed from the difference of the modeled lambda signal and a lambda signal measured using said broadband lambda probe or from the difference of a signal derived from the modeled lambda signal and a signal derived from the measured lambda signal as an input variable of a controller connected upstream of a model in the observer wherein an electrical circuitry or a program sequence for determining a measure for the dynamic characteristics of said broadband lambda probe from an evaluation of the estimation error signal or of a variable derived therefrom is provided in the engine control unit and in that a comparison of the measure for the dynamic characteristics of said broadband lambda probe with predefined limits is provided to evaluate to what extent said dynamic characteristics of said broadband lambda probe are sufficient for an intended operation of said internal combustion engine.
